(19) United States
(12) Patent Application Publication
(10) Pub. No.: US 2016/0146405 A1
(43) Pub. Date: May 26, 2016

(54) OPTICAL SEMICONDUCTOR LIGHTING APPARATUS

(71) Applicant: POSCO LED COMPANY LTD., Seongnam-si (KR)

(72) Inventors: Jin Jong KIM, Seongnam-si (KR); Dong Hee KIM, Seongnam-si (KR); Kyung Rye KIM, Seongnam-si (KR); Dae Won KIM, Seongnam-si (KR); Jung Hwa KIM, Seongnam-si (KR)

(21) Appl. No.: 14/552,989

(22) Filed: Nov. 25, 2014

(51) Int. Cl. F21K 99/00; F21V 23/02; F21V 29/74; F21V 23/00

(52) U.S. Cl. CPC F21K 9/135; F21V 23/003; F21V 23/02; F21V 29/74; F21Y 2101/02

(57) ABSTRACT

An optical semiconductor lighting apparatus includes: an upper body open at a lower side thereof to define an interior space therein and formed on an outer surface thereof with an upper protrusion; a lower body open at an upper side thereof to define an interior space therein and formed on an outer surface thereof with a lower protrusion placed collinear with the upper protrusion; one or more heat sinks each including a fastening assembly into which the upper protrusion and the lower protrusion are inserted; and a light emitting module including one or more optical semiconductor devices placed on one side surface of each of the heat sinks, wherein the heat sinks surround outer surfaces of the upper body and the lower body.

### BACKGROUND

1. Field

Exemplary embodiments relate to an optical semiconductor lighting apparatus. More particularly, exemplary embodiments relate to an optical semiconductor lighting apparatus, which can realize pleasant lighting while improving aesthetics through balance with surrounding landscape.

2. Discussion of the Background

Optical semiconductor devices, such as light emitting diodes (LEDs) or laser diodes (LDs), have attracted increasing attention due to advantages such as low power consumption, long lifespan, high durability, and excellent brightness, as compared with incandescent lamps or fluorescent lamps.

Unlike fluorescent lamps or mercury lamps manufactured by injecting argon gas and toxic mercury into a glass tube, optical semiconductor devices do not use substances toxic to the environment, thereby providing eco-friendly products.

Particularly, lighting apparatuses using optical semiconductor devices as a light source are recently employed for outdoor landscape lighting or security, and thus easy assembly and installation thereof is required.

In addition, such lighting apparatuses using optical semiconductor devices as a light source are required to allow replacement or repair upon failure and malfunction.

The above information disclosed in this Background section is only for enhancement of understanding of the background of the inventive concept, and, therefore, it may contain information that does not form the prior art that is already known in this country to a person of ordinary skill in the art.

### SUMMARY

The present invention has been conceived to solve such problems in the related art and is aimed at providing an optical semiconductor lighting apparatus, which can realize pleasant lighting while improving aesthetics through balance with surrounding landscape.

Additional aspects will be set forth in the detailed description which follows, and, in part, will be apparent from the disclosure, or may be learned by practice of the inventive concept.

In accordance with one aspect of the present invention, an optical semiconductor lighting apparatus includes: an upper body open at a lower side thereof to define an interior space therein and formed on an outer surface thereof with an upper protrusion; a lower body open at an upper side thereof to define an interior space therein and formed on an outer surface thereof with a lower protrusion placed collinear with the upper protrusion; one or more heat sinks each including a fastening assembly into which the upper protrusion and the lower protrusion are inserted; and a light emitting module including one or more optical semiconductor devices placed on one side surface of each of the heat sinks, wherein the heat sinks surround outer surfaces of the upper body and the lower body.

The optical semiconductor lighting apparatus may further include an Edison base formed on a lower end of the lower body, and a base holder provided to the lower end of the lower body and fastened to the Edison base.

The optical semiconductor lighting apparatus may further include a fastening member connecting the upper body to the lower body, wherein a lower edge of the upper body corresponds to an upper edge of the lower body.

A lower end of the upper body may be inserted into an upper end of the lower body.

An upper end of the lower body may be inserted into an upper end of the upper body.

The heat sinks may surround the outer surfaces of the upper body and the lower body to form a polygonal pillar.

The polygonal pillar may have one shape selected from among a triangular pillar shape, a square pillar shape, a pentagonal pillar shape, a hexagonal pillar shape, a heptagonal pillar shape, and an octagonal pillar shape.

Each of the heat sinks may be formed at one side surface thereof with a through-hole through which an interconnection wire for supplying power to the light emitting module passes.

The optical semiconductor lighting apparatus may have a wire passage at a portion at which the lower end of the upper body engages with the upper end of the lower body.

The interior space of the upper body or the lower body may be provided with a power supply unit or a drive circuit.

The optical semiconductor lighting apparatus may further include a plurality of heat dissipation fins protruding from the other side surface of the heat sink, wherein the fastening assembly is formed at a central region of the plurality of heat dissipation fins.

The optical semiconductor lighting apparatus may further include a plurality of heat dissipation fins protruding from the other side surface of the heat sink, wherein the fastening assembly is formed at a central region of the other side surface of the heat sink.

The fastening assembly may include a pair of protruding pieces protruding from a central region of a heat dissipation base constituting one surface of the heat sink, and securing pieces each extending along edges of the protruding pieces and secured to the outer surfaces of the upper body and the lower body.

The optical semiconductor lighting apparatus may further include at least one fastening slot formed on outer surfaces of the upper body and the lower body to be collinear with the upper and lower protrusions and receiving the fastening assembly, wherein the upper protrusion and the lower protrusion are placed in the fastening slot.

The optical semiconductor lighting apparatus may further include a plurality of upper protrusions arranged at constant intervals along the outer surface of the upper body, and a plurality of lower protrusions arranged at constant intervals along the outer surface of the lower body.

A plurality of heat sinks may form an air passage having a constant width therebetween.

The heat sinks may be separated a constant distant from each other.

According to embodiments of the present invention with the structure as described above, a light emitting module is placed in each of a plurality of heat sinks radially disposed on an outer surface of a housing provided with an Edison base such that light can be irradiated in four directions while becoming orthogonal to the Edison base, thereby realizing pleasant lighting while improving aesthetics through balance with surrounding landscape.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a perspective view of an overall structure of an optical semiconductor lighting apparatus according to one embodiment of the present invention.

FIG. 2 is an exploded perspective view of the overall structure of the optical semiconductor lighting apparatus according to the embodiment of the present invention.

FIG. 3 is a partial perspective view of a housing of the optical semiconductor lighting apparatus according to the embodiment of the present invention.

FIG. 4 is a perspective view of a remaining structure of the housing of the optical semiconductor lighting apparatus according to the embodiment of the present invention.

FIGS. 5(a) and 5(b) are perspective views of a heat sink of the optical semiconductor lighting apparatus according to the embodiment of the present invention.

FIG. 6 is a side view of the housing of the optical semiconductor lighting apparatus according to the embodiment of the present invention, with the heat sink separated from a light emitting module.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

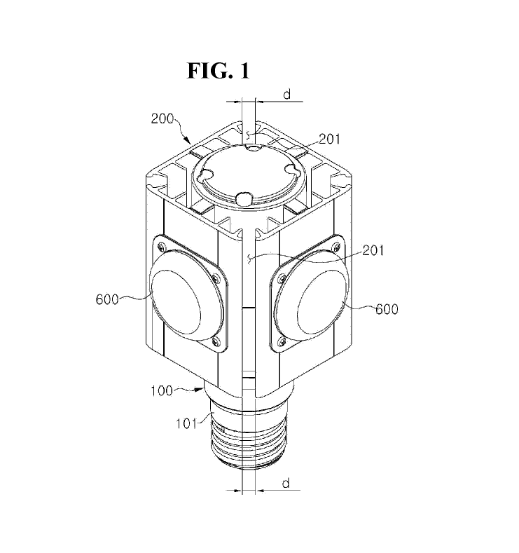

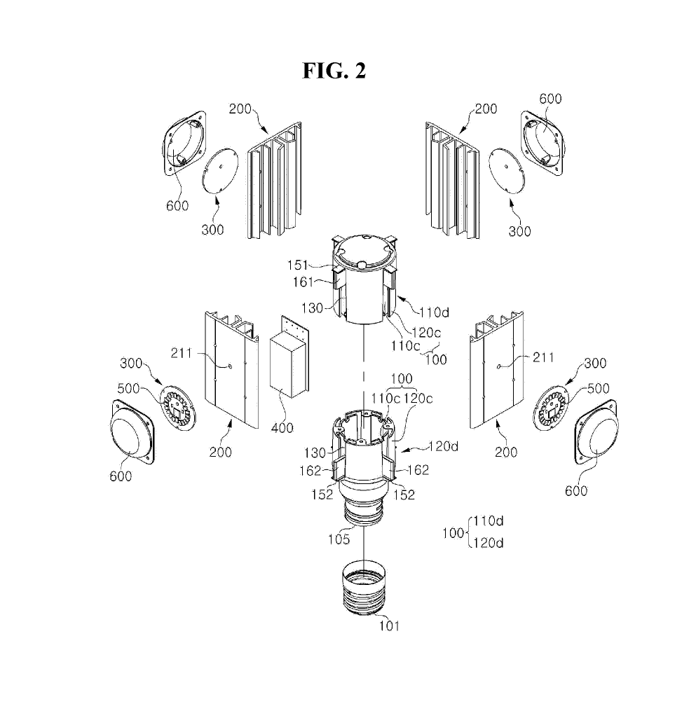

FIG. 1 is a perspective view of an overall structure of an optical semiconductor lighting apparatus according to one embodiment of the present invention, and FIG. 2 is an exploded perspective view of the overall structure of the optical semiconductor lighting apparatus according to the embodiment of the present invention.

Referring to FIGS. 1 and 2, an optical semiconductor lighting apparatus according to one embodiment of the invention includes a housing 100, heat sinks 200, and light emitting modules 300.

The housing 100 is electrically connected to a socket (not shown) and provides a space and area on which the heat sinks 200 described below are mounted. The housing 100 may be generally divided into an upper body 110d and a lower body 120d.

The upper body 110d is open at a lower side thereof to define an interior space therein and is formed on an outer surface thereof with an upper protrusion 161.

The lower body 120d is open at an upper side thereof to define an interior space therein and is formed on an outer surface thereof with a lower protrusion 162, which is placed collinear with the upper protrusion 161.

The upper and lower protrusions 161, 162 serve as support members for supporting both ends of a fastening assembly 230 described below.

The optical semiconductor lighting apparatus includes one or more heat sinks 200. Here, each of the heat sinks 200 includes the fastening assembly 230 into which the upper protrusion 161 and the lower protrusion 162 are inserted, and serves to provide efficient dissipation of heat from the light emitting module 300.

The light emitting module 300 includes one or more optical semiconductor devices 500 placed on one side surface of the heat sink 200 and acts as a light source.

The heat sinks 200 surrounds outer surfaces of the upper body 110d and the lower body 120d.

It should be understood that the following various embodiments as well as the above embodiment may be applied to the present invention.

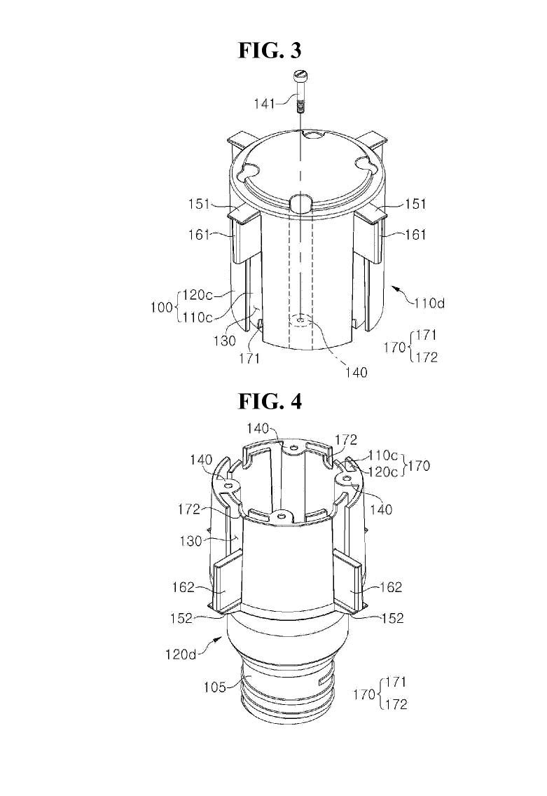

For reference, FIG. 3 is a partial perspective view of the housing of the optical semiconductor lighting apparatus according to the embodiment of the present invention, and FIG. 4 is a perspective view of a remaining structure of the housing of the optical semiconductor lighting apparatus according to the embodiment of the present invention.

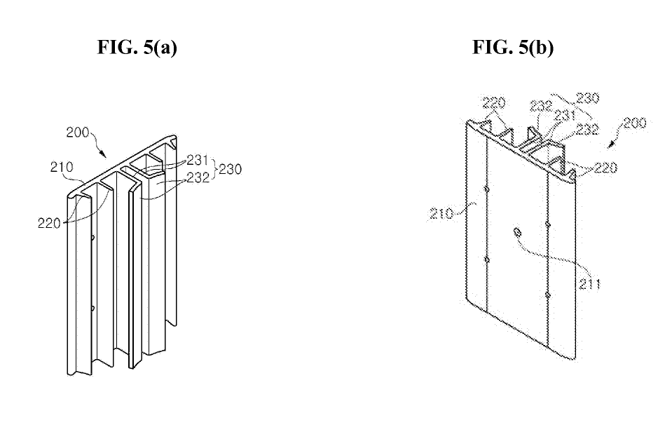

FIGS. 5(a) and 5(b) are perspective views of the heat sink of the optical semiconductor lighting apparatus according to the embodiment of the present invention

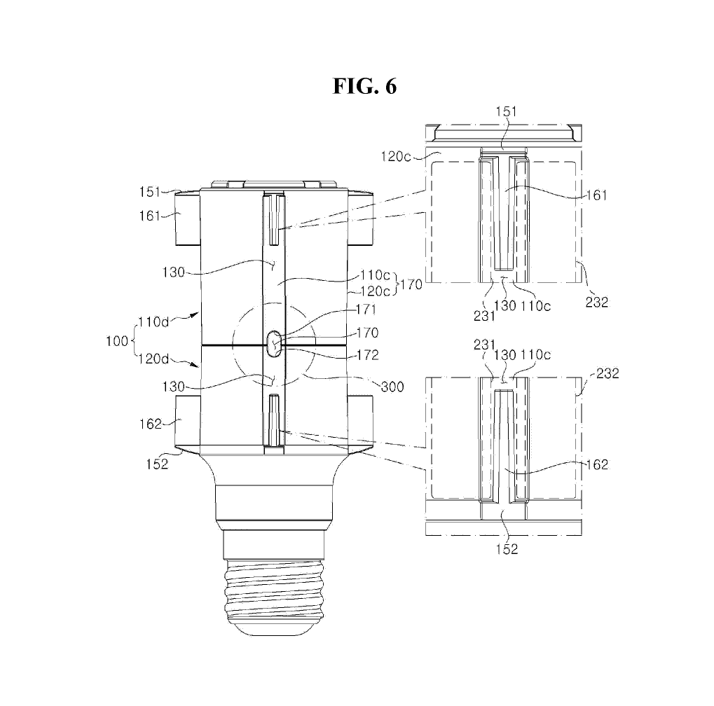

In addition, FIG. 6 is a side view of the housing of the optical semiconductor lighting apparatus according to the embodiment of the present invention, with the heat sink separated from the light emitting module.

According to the invention, the lower body 120d is formed at a lower end thereof with an Edison base 101, which will be coupled to a socket (not shown).

Specifically, the Edison base 101 serves as an electric contact, which is screwed to the socket and receives electric power from a power source.

For convenience in fastening and assembly of the Edison base 101, the optical semiconductor lighting apparatus may further include a base holder 105 provided to the lower end of the lower body 120d and fastened to the Edison base 101.

As shown in FIGS. 3 and 4, in some embodiments, a lower edge of the upper body 110d may correspond to an upper edge of the lower body 120d, and the optical semiconductor lighting apparatus may further include a fastening member 140 connecting the upper body 110d to the lower body 120d.

That is, the upper body 110d and the lower body 120d are fastened to each other by fasteners 141 such as bolts and nuts through the fastening member formed on each of the upper body 110d and the lower body 120d, thereby forming the housing 100.

Although not specifically shown, it should be understood that the housing 100 may have other fastening structures in addition to the above fastening structure. For example, a lower end of the upper body 110d may be inserted into an upper end of the lower body 120d, or the upper end of the lower body 120d may be inserted into an upper end of the upper body 110d.

On the other hand, according to the present invention, a wire passage 170 may be formed at a portion at which the lower end of the upper body 110d engages with the upper end of the lower body 120d, such that an interconnection wire for supplying power to the light emitting module 300 extends into the interior spaces of the upper body 110d and the lower body 120d.

The interior space of the upper body 110d or the lower body 120d may be provided with a power supply unit 400 or a drive circuit (not shown) connected to the light emitting module 300 through the interconnection wire.

Referring to FIGS. 3, 4 and 6, the wire passage 170 may be divided into a first wire passage half 171 and a second wire passage half 172.

First, before referring to the first wire passage half 171 and the second wire passage half 172, the housing 100 may be divided into the upper body 110d and the lower body 120d according to the division structure thereof, or may be divided into first and second barrels 110c, 120c according to the coupling structure with respect to the heat sink 200.

The first barrel 110c defines an interior space which receives the power supply unit 400 electrically connected to the light emitting module 300.

The second barrel 120c has an inner periphery facing an outer periphery of the first barrel 110c and is placed outside the first barrel 110c.

Here, the heat sink 200 is coupled between the first and second barrels 110c, 120c.

Such first and second barrels 110c, 120c are formed by coupling the upper and lower bodies 110d, 120d to each other via the fastening member 140.

Here, the housing 100 further includes one or more fastening slots 130, which are formed on the outer surface of each of the upper body 110d and the lower body 120d and receive the fastening assemblies 230, such that the upper and lower protrusions 161, 162 can be received in each of the fastening slots 130.

Preferably, the lighting apparatus includes a plurality of upper protrusions 161 and a plurality of lower protrusions 162 arranged at constant intervals along the outer peripheries is of the upper and lower bodies 110d, 120d to form a polygonal pillar described below.

Thus, the first wire passage half 171 is formed in an arc shape by upwardly convexly cutting a lower edge of the upper body 110d, that is, a lower edge of an upper portion of the first barrel 110c divided into upper and lower portions, as shown in FIG. 6, and is placed corresponding to each of the fastening slots 130.

The second wire passage half 172 is formed in an arc shape by downwardly convexly cutting an upper edge of the lower body 120d, that is, an upper edge of a lower portion of the first barrel 110c divided into the upper and lower portions, as shown in FIG. 6, and is placed corresponding to each of the fastening slots 130.

Accordingly, when the upper body 110d integrally engages with the lower body 120d, the first wire passage half 171 and the second wire passage half 172 placed corresponding to each of the fastening slots 130 engage with each other to form the wire passage 170 having a circular or oval shape.

Here, the optical semiconductor device 500 of the light emitting module 300 may be electrically connected to the power supply unit 400 via an interconnection wire (not shown) passing through the wire passage 170.

On the other hand, the heat sinks 200 surround the outer surfaces of the upper body 110d and the lower body 120d to form a polygonal pillar. The polygonal pillar may have one shape selected from among a triangular pillar shape, a square pillar shape, a pentagonal pillar shape, a hexagonal pillar shape, a heptagonal pillar shape, and an octagonal pillar shape.

Thus, the optical semiconductor device 500 of the light emitting module 300 mounted on each of the heat sinks 200 emits light orthogonal to the Edison base 101.

The heat sink 200 may be formed at one side surface thereof with a through-hole 211 through which the interconnection wire for supplying power to the light emitting module 300 passes.

The heat sinks 200 are separated a constant distance from each other, and form an air passage 201 having a constant width therebetween, thereby further improving cooling performance through natural convection.

In addition, the optical semiconductor lighting apparatus according to the invention may further include a plurality of heat dissipation fins 220 protruding from the other side surface of the heat sink 200. In this case, the fastening assembly 230 is advantageously formed at a central region of the plural heat dissipation fins 220, that is, at a central region of the other side surface of the heat sink 200, in terms of the fastening and placement structure.

Thus, the fastening assembly 230 includes a pair of protruding pieces 231 protruding from a central region of a heat dissipation base 210 constituting one surface of the heat sink 200, and securing pieces 232 extending along edges of the protruding pieces 231 and secured to the outer surfaces of the upper body 110d and the lower body 120d.

As described above, the optical semiconductor lighting apparatus according to the present invention can realize pleasant lighting while improving aesthetics through balance with surrounding landscape.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An optical semiconductor lighting apparatus comprising:
an upper body open at a lower side thereof to define an interior space therein and formed on an outer surface thereof with an upper protrusion;
a lower body open at an upper side thereof to define an interior space therein and formed on an outer surface thereof with a lower protrusion placed collinear with the upper protrusion;
one or more heat sinks each including a fastening assembly into which the upper protrusion and the lower protrusion are inserted; and
a light emitting module including one or more optical semiconductor devices placed on one side surface of each of the heat sinks,
wherein the heat sinks surround outer surfaces of the upper body and the lower body.

2. The optical semiconductor lighting apparatus according to claim 1, further comprising:
an Edison base formed on a lower end of the lower body; and
a base holder provided to the lower end of the lower body and fastened to the Edison base.

3. The optical semiconductor lighting apparatus according to claim 1, further comprising:
a fastening member connecting the upper body to the lower body,
wherein a lower edge of the upper body corresponds to an upper edge of the lower body.

4. The optical semiconductor lighting apparatus according to claim 1, wherein a lower end of the upper body is inserted into an upper end of the lower body.

5. The optical semiconductor lighting apparatus according to claim 1, wherein an upper end of the lower body is inserted into an upper end of the upper body.

6. The optical semiconductor lighting apparatus according to claim 1, wherein the heat sinks surround the outer surfaces of the upper body and the lower body to form a polygonal pillar.

7. The optical semiconductor lighting apparatus according to claim 6, wherein the polygonal pillar has one shape selected from among a triangular pillar shape, a square pillar shape, a pentagonal pillar shape, a hexagonal pillar shape, a heptagonal pillar shape, and an octagonal pillar shape.

8. The optical semiconductor lighting apparatus according to claim 1, wherein each of the heat sinks is formed at one side surface thereof with a through-hole through which an interconnection wire for supplying power to the light emitting module passes.

9. The optical semiconductor lighting apparatus according to claim 1, wherein the optical semiconductor lighting apparatus has a wire passage at a portion at which the lower end of the upper body engages with the upper end of the lower body.

10. The optical semiconductor lighting apparatus according to claim 1, wherein the interior space of the upper body or the lower body is provided with a power supply unit or a drive circuit.

11. The optical semiconductor lighting apparatus according to claim 1, further comprising:
a plurality of heat dissipation fins protruding from the other side surface of the heat sink,
wherein the fastening assembly is formed at a central region of the plurality of heat dissipation fins.

12. The optical semiconductor lighting apparatus according to claim 1, further comprising:
a plurality of heat dissipation fins protruding from the other side surface of the heat sink,
wherein the fastening assembly is formed at a central region of the other side surface of the heat sink.

13. The optical semiconductor lighting apparatus according to claim 1, wherein the fastening assembly comprises a pair of protruding pieces protruding from a central region of a heat dissipation base constituting one surface of the heat sink, and securing pieces each extending along edges of the protruding pieces and secured to the upper body and the lower body.

14. The optical semiconductor lighting apparatus according to claim 1, further comprising:
at least one fastening slot formed on outer surfaces of the upper body and the lower body to be collinear with the upper and lower protrusions and receiving the fastening assembly,
wherein the upper protrusion and the lower protrusion are placed in the fastening slot.

15. The optical semiconductor lighting apparatus according to claim 14, further comprising:
a plurality of upper protrusions arranged at constant intervals along the outer surface of the upper body, and a plurality of lower protrusions arranged at constant intervals along the outer surface of the lower body.

16. The optical semiconductor lighting apparatus according to claim 1, wherein a plurality of heat sinks form an air passage having a constant width therebetween.

17. The optical semiconductor lighting apparatus according to claim 1, wherein the heat sinks are separated a constant distance from each other.
